(19) United States
(12) Patent Application Publication
(10) Pub. No.: US 2014/0011557 A1
(43) Pub. Date: Jan. 9, 2014

(54) WORD GAMES BASED ON SEMANTIC RELATIONSHIPS AMONG PLAYER-PRESENTED WORDS

(71) Applicant: Ian Patrick Coyle, Fort Lauderdale, FL (US)

(72) Inventor: Ian Patrick Coyle, Fort Lauderdale, FL (US)

(21) Appl. No.: 13/901,537

(22) Filed: May 23, 2013

Related U.S. Application Data
(60) Provisional application No. 61/650,485, filed on May 23, 2012.

(51) Int. Cl. G07F 17/32

(52) U.S. Cl. CPC G07F 17/3286
USPC 463/9

(57) ABSTRACT

The invention provides methods and apparatus for playing word games wherein competition is based primarily upon semantics skills, and more particularly, word games in which players compete by presenting words upon a gameboard in alternating turns, wherein each presented word is responsive to one or more previously presented words according to semantic criteria, and wherein the quality and nature of semantic relationships between opponents' words determines scores, rankings, and outcomes. Said semantic criteria comprise synonymy, antonymy, and genus-species relationships, for example. The game is provided as a physical boardgame and as a software application to be played on personal computing devices and over a network such as the internet against either human opponents or artificial intelligence-based computer opponents.

### CROSS REFERENCE TO RELATED APPLICATIONS

This application claims the benefit of U.S. Provisional Application No. 61/650,485 filed on May 23, 2012, the entirety of which is incorporated by reference herein.

### BACKGROUND OF THE INVENTION

1. Field of the Invention

The present invention relates to methods and apparatus for playing word games wherein competition is based primarily upon semantics skills, and more particularly, word games in which players compete by presenting words upon a gameboard in alternating turns, wherein each presented word is responsive to one or more previously presented words according to semantic criteria, and wherein the quality and nature of semantic relationships between opponents' words determines scores, rankings, and outcomes. Said semantic criteria comprise synonymy, antonymy, and genus-species relationships, for example.

2. Description of the Related Art

The following review of related art is intended to provide edifying examples of problems and pitfalls in the design, use, and play of word games. The mention of these examples does not constitute an admission that any of the following subject matter constitute prior art applicable to the present invention. The discussion of the references states what their authors assert, and the applicant reserves the right to challenge the accuracy and pertinency of any of the documents cited herein.

Word games are generally played by multiple opposing players, where an opposing player may be a computerized artificial intelligence or another person playing remotely over a digital communication means, who manipulate lettered tiles in contiguous linear sequences. Typically, the lettered tiles are arrayed upon a two-dimensional grid to spell words, and a play by a player typically comprises the selection of letters and their placement upon the grid to form a word.

SCRABBLE® is a paragon of one genre of word games known as tile-and-grid word games, also called crossword games or word-forming games. In crossword games like SCRABBLE, each tile typically bears one letter and each letter is assigned a point value for scoring purposes. The gameboard and/or the letter tiles may contain special designations that can amplify or diminish point scores under certain conditions, such as in SCRABBLE when tiles are placed in “double word score” squares on the gameboard. The criteria for determining the validity of a word offered by a player during his or her turn typically comprise (1) that the sequence of letters correspond identically with a word in a standardized reference lexicon such as an English language dictionary, and (2) that at least one letter of the offered word is derived from a tile on the game board in a previously presented word. Players begin with a certain number of tiles, they draw new tiles at the end of each turn to replenish tiles played on the gameboard, and the object of the game is to accumulate maximum point scores by incorporating high-value tiles into words. A crossword game typically ends when a player exhausts his or her inventory of tiles. There is no other criteria for judging and scoring a word other than board position and correct spelling of the word—meaning that semantic relationships between words are not essential to the game.

In another broad category of popular word games, players compete in word recognition puzzles or anagrams. Stackable crossword games like UPWORDS and SCRABBLE-SLAM require players to replace letters in preexisting words to make new words. Importantly, the eligibility of each new word offered by a player is not constrained by its semantic relationship to other words on the gameboard. The game CRANIUM incorporates anagrams, spelling contests, and lexicon testing. Lexicon testing requires a player to properly define a quiz word, but does not require players to identify further related words, as in subsequent rounds of play, based upon either the quiz word or the answer word. Anagram and word-search games known in the prior art today may involve isolated semantic challenges, but each challenge is posed by the game to an individual player or to the players collectively, and not from one player to another continuously throughout play as the basis for determining the outcome of every turn and round of play.

Other word game concepts are found throughout the patent literature, but games based on semantics are exceedingly underrepresented. Of those games which do involve semantics, none require players to compete by presenting words directly in response to the semantic features of an opponent's word choices. U.S. Pat. No. 7,980,930 to Moreno entitled, “ON-LINE GAME BASED ON WORDS, MAKING USE OF A SEARCH ENGINE,” issued Jul. 19, 2011 (“The “Moreno patent”), the entirety of which is incorporated by reference herein, requires players to anticipate whether the artificial intelligence of a search engine will consider two words to be related. Search engines uses various algorithms to evaluate relationships between words using both linguistic and non-linguistic considerations (e.g., syntactical and cultural factors, historical statistics of search string entries, probabilistic analysis of how frequently two words will co-occur on a single web page, how far apart the query words are situated within a page or a block of text, and other criteria). In the Moreno patent, an artificial intelligence of the game presents a first word, and then one or more players seek to find a series of additional words which, when combined with the initial word, maximize the number of co-occurrences and the proximity of co-occurrence of the words when submitted to a search engine. The primary criteria for determining word relationships here is thus based on syntax and not semantics. This game rewards players for the superior ability to identify words that are most commonly published together on the internet. It is not based on dictionaries or thesauri, and it explicitly disclaims the testing of “knowledge or erudition,” and thus it disclaims semantics, in column 2 lines 6-7 of the specification.

U.S. Pat. No. 7,216,868 to Groz et al., entitled, “Word Forming Board Game with Lettered Tiles,” issued May 15, 2007, is a modified crossword game which resembles SCRABBLE in most respects, except that words on the game board may be modified by removing tiles from them and adding new tiles to them, thus forming a new word in place of a previous word, so long as at least one tile from the previous word remains undisturbed. U.S. Pat. No. 7,140,613 to Glikmann entitled, “Scrambled Word Game,” issued Nov. 28, 2006 (“The Glikmann patent”) and a series of related patents discussed in the specification therein, are anagram games in which players compete to form permutations of a given word that is presented on a card drawn from a deck of cards provided in the game, wherein each card contains a scrambled set of letters and a complete list of all valid permutations. Similar inventions incorporate the essence of the “hangman” game, wherein players compete to fill in blanks spaces with certain words or letters corresponding to a clue. In some anagram games, players perform semantics operations, although in a very limited manner, such as when a player is given clues to the letters or words which he or she is seeking, said clues being provided in the form of synonyms, antonyms, classifications, or other descriptive language hinting at the missing letters or answer words. Nevertheless, anagram word play relates to spelling and not to semantics.

U.S. Pat. No. 7,044,467 to Dimmig, entitled “Sentence Forming Game and Its Associated Method of Play,” issued May 16, 2006 (“The Dimmig patent”), involves semantics as a secondary consequence of the game being based more broadly upon the goal of forming sentences from assorted tiles wherein a single random word is printed on each tile. The game is played on a boardspace comprising a grid with specialty squares, analogous to a SCRABBLE board. A first player forms a sentence by arranging a series of tiles, each tile containing a single word or a wildcard, which is then either modified or intersected by a second player forming a second sentence. The goal of the game is for each player to form a grammatically, syntactically, and linguistically correct sentence once per turn. The goal is not, it should be noted, to score points by purposefully presenting synonyms, antonyms, or related words in conjunction with the words already present on the gameboard. This game is merely a crossword game using words as the tile units instead of individual letters.

Further examples of word games involving permutation or transformation of words include the invention described in U.S. Pat. No. 6,116,604 to Vandelli, entitled, “Word Transformation Game,” issued Sep. 12, 2000, the entirety of which is incorporated by reference herein. A player competes only in solitary mode, and the game entails responding to a prompt, wherein said prompt is the definition of a word, by attempting to type in the correct answer word. Next, that word is transformed into a second answer word by rearranging all the letters of the word except for two of said letters. Although this game incorporates semantics skills challenges, it does not involve direct competition among multiple players or direct matching of words based on the underlying semantic properties of the matched words. It is a hybrid anagram game and vocabulary-builder.

Word Games and game systems may be configured in various arrangements of hardware and software known in the art. See, for example, U.S. Pat. No. 8,337,305 to Aronzon, issued Dec. 25, 2012, entitled “Apparatus and method for managing user inputs in video games,” the entirety of which is incorporated by reference herein; and, U.S. Pat. No. 8,146,920 to Hacker, issued Apr. 3, 2012, entitled “Tile game apparatus and method for learning alphabet-based symbolic notation,” the entirety of which is incorporated by reference herein.

In light of the above, there exists a need for a novel type of word game that allows players to compete based on (a) the breadth and depth of their semantic understanding of a lexicon, such as the English language, (b) the ability to precisely, accurately, and quickly identify semantic relationship between words, and (c) the strategic and tactical application of semantics in the context of organizing pairs or groups of words. Secondarily and advantageously, such a game would educate and motivate both participants and observers to hone and expand their skills relating to semantics, which would in turn promote improvement in other related linguistic faculties. The field of word games is crowded with recycled versions of crossword and anagram games that limit players to competition on the lexicological level, or the lowest level, of linguistic operation. Therefore, there exists an unmet need among consumers, educators, game manufacturers, and society as a whole for word games that stimulate the semantically-oriented areas of the mind.

### SUMMARY OF THE INVENTION

The game of the present invention satisfies the above needs. It describes methods and apparatus comprising an array of word games varying around the central competitive concepts enumerated in points (a)-(c), above. In at least one embodiment, the present invention may be marketed under the trade name, “War of Words.”

In a preferred configuration, the present invention relates to methods and apparatus for playing a word game in which players compete by presenting synonyms, antonyms, or otherwise semantically-related words in response to words previously presented upon a gameboard by one or more opponents. Said gameboard may comprise means for displaying one or more visual representations of player-presented words on said gameboard and also means for visually representing said semantic relationships among said player-presented words. As such, a gameboard may comprise an object in the physical world for use by players physically gathered around said gameboard, and it may comprise a digital, virtual, graphical, or computer-based gameboard to be used by one or more persons via one or more electronic devices. An artificial intelligence (game monitor or “GM”) is provided as a means for managing the progress of the game, including the events that occur before, during, after, and due to each player turn. The GM monitors gameplay, for example by determining semantic relationships in and among words as they are presented by the players, by assigning consequences and point scores to said players based on said relationships, and by generating responsive, interactive audiovideo events and characters on the gameboard to reflect the outcome of the players' actions. The game may be played both on digital devices equipped with audio or video display means and on traditional gameboards integrated with assistive computer hardware and software elements. Each of the functions of the GM may be assigned to a particular software application or hardware device depending on the type of system on which the game is to be played.

### GLOSSARY

Lexicon: The lexicon of a language is the vocabulary or wordstock of said language. The term lexicon is generally used in the context of a single language. Lexicalization: the process of inserting new words in to a lexicon. Lexicography: the theory and practice of composing dictionaries. Lexicology: a subdiscipline of linguistics which studies words, their nature and meaning.

Dictionary: A dictionary, in the most rudimentary form, is an alphabetized list of the individual words constituting a lexicon wherein each word is presented in conjunction with its definition. Dictionaries may differ in the specificity or brevity of the definitions they provide as well as the scope of alternative definitions, such as secondary or antiquated definitions, they provide. The most elaborate dictionaries may expound upon etymological, linguistic, grammatical, and various other data applicable to the words in a lexicon.

Semantic: (adj.) of, pertaining to, or arising from the different meanings of words or symbols, especially within the context of a language; Of, relating to, or according to the science of semantics. Semantics: the study of meaning; the study of the relation between signifiers, such as words, phrases, signs and symbols, and what they stand for, their denotata; a method for defining and distinguishing the meanings and relationships of words or other content in expressions and statements; Lexical semantics: the study of how and what the words of a language denote; classification and decomposition of word meanings; categorizing or organizing words according to defined criteria or relationships such as homonymy, synonymy, antonymy, paronymy, etc.

In light of the above information, the terms “lexicon” and “dictionary” may be used broadly herein and should not be regarded as limiting in any particular instance unless explicitly stated as such. Although the most stringent way to define the core concept of the present invention is that players compete according to lexical semantics, the term semantics is used interchangeably and is intended to encompasses “lexical semantics” throughout this disclosure and the claims unless otherwise specified.

### A First Example Embodiment of a Series of Game Scenarios

Before beginning gameplay, players assign values to adjustable game parameters via menu navigation, fillable forms, manual dials and buttons, keyboards or voice-activated input accessories, or other interactive option-selection mechanisms known by persons skilled in the relevant arts for programming game conditions and preferences prior to and during the playing of a game. These optionally selectable parameters comprise a wide variety of features, explained more fully below, at least including the colors which will be used to represent each player and his or her words on the video display element of the game system wherein the gameboard and attendant gameplay information are depicted.

In a preferred embodiment, a first player types, speaks, or otherwise presents a first word to the game monitor (GM) using any means for inputting data known in the art. The GM comprises artificial intelligence and other technological means for executing functions and controlling software- and hardware-based elements of the game system. The game system may comprise a self-contained system, for example comprising a gameboard and a Game Monitor, and in many embodiments the game system may comprise only software for execution on commercial electronic devices, computer terminals, web-based applications, and the like. The first word presented by the first player is evaluated by the GM for approval of its validity, such as for its correct spelling and inclusion in a recognized lexicon. Upon approval by the GM, the first word is then output to the gameboard where it is visible to all players. Said gameboard may comprise an animated grid, queue, stack, column, or other geometric framework amenable to displaying or animating sequences of words. The characters or letters making up a word may comprise text, inscripted tiles, animated font text, animated tiles, or other visible depictions of the word. Each word is initially displayed in the color and style indicative of the player presenting the word, in order to indicate his or her dominion over said word, where dominion refers to which player is due credit for the value of the word according to game scoring rules. In preferred embodiments, dominion over any word can be seized by opponents during gameplay according to various contingencies. Changes in dominion over words are typically accompanied by changes in the graphical representation of said words, such as a transformation of the word's color and style to match that of the acquiring player. Changes in dominion of words may also be accompanied by animations, music, sound bytes and film clips, as well as messages and notifications, such as messages conveying explanatory information like definitions from a lexicon or dictionary, taunts, exclamatory statements, and any other information that enhances gameplay, provides education, entertains, or otherwise achieves the goals of the game system.

After the first player successfully presents the first word on the gameboard, a second player responds by presenting a responsive word to the GM, whereupon the GM evaluates the responsive word not only for validity, as above, but also for semantic relationship to the first word. Players may customize the semantic and relational criteria to be applied by the GM in any game when they set the adjustable parameters prior to beginning the game. Typically, and by default, the GM will compare words according to antonymy, synonymy, and common category, but other semantic criteria may include convergent connotations, genus-species relationships, and the like. After a responsive word is found valid by the GM, said responsive word is output to the display and appears adjacent to the first word on the gameboard. In the preferred embodiment, the second word appears directly above the first word in an ascending stack configuration.

At this point in the example, the responsive word is displayed on the gameboard in the color and style characterizing its dominion under the second player, while the first word is displayed immediately underneath it in the color and style corresponding to the dominion of the first player. After a brief delay, the words will undergo animated transformations that vary depending on how the words relate to each other semantically and which rules the players have elected to abide by in the game. For example, if the rules of the game decree that an antonym destroys an opponent's word, and if the responsive word in this example were an antonym of the first word, then the first word may explode while the responsive word descends to occupy the first word position on the gameboard, which in this example is the base of a vertical queue. Simultaneously, the game may emit the sound of an explosion and display a message describing the result, such as “Antonym annihilation!”

Alternatively, if the responsive word is a synonym of the first word, a different animation may ensue in which the first word adopts the style and color of the responsive word, thus indicating that the second player has seized dominion over the first word away from its former dominion under the first player. This outcome may be accompanied by applicable sounds and video and a message such as “Synonym snatched by Player Two!” If the two words are not sufficiently related by semantics, the converse may occur and Player One may acquire dominion over the responsive word, and the color and style of the responsive word will then transform to correspond to Player One, while the GM may issue a message such as “Unrelated Word Foul! Player Two Forfeits Word to Player One.”

In parallel to the events on the gameboard, other portions of the video display element(s) of the game apparatus may display text, animations, clips, or other information to explain, educate, and entertain the players. Such displays may include excerpts from and commentary on game rules, dictionaries, and thesauri, as well as strategy tips, internet web pages, animations, movies, and the like.

Depending on the outcome of the first round, either one or both presented words remain on the gameboard and persist in their positions when the next round begins. Let us assume in this example for the purposes of illustration that the first word was “Love” and the responsive word was “Hate.” Being antonyms, the responsive word annihilated the first word and now only the responsive word “Hate” remains in the queue of the gameboard. The responsive word “Hate” has retained the coloration and style indicative of its dominion under player two. After the outcome of the interaction between the responsive word and first word are completed, and after all ancillary audio video events of the round are completed, the round is over and a new round begins.

In round two, Player One again presents a first word according to the same criteria as before, only now the first word will be evaluated for both validity and interaction with the word “Hate” which resides in the first position of the gameboard queue. If valid, the first word of round two will be displayed in the second position of the gameboard queue, which in this case is the position immediately above the word “Hate.” Let us assume in this example that the first word of round two is “Loathe.” Because “Loathe” is a synonym of “Hate,” player one has executed a synonym snatch. The outcome on the gameboard is the transformation of the color and style of “Hate” to those of player one. The queue now consists of two words in two colors/styles, from bottom to top: “Hate” (player one dominion) and “Loathe” (player one dominion).

Next, player two begins his or her responsive turn of round two. Player two presents the word “Resent” which is evaluated by the GM for validity and relationship to the other words in the gameboard queue. Although “Resent” is semantically related to “Loathe,” it is not a primary or direct synonym. In such a case, the GM may determine that the word is either not semantically related or that it is “somewhat related.” The availability of the “somewhat related” rules is adjustable by the players when setting up the game and is applied in the default rules of the preferred embodiment. Because this example assumes that the “somewhat related” rule is on, the outcome of player two's move is a parry, in that player two is deemed to have presented a neutral word and player two retains dominion over it, while the game will display a comment like, “Related Word Parry!” Then, the word “Resent” is displayed in the third slot in the queue of the gameboard in the color and style of player two. Round two is over, and the queue now comprises three words, listed from bottom to top, as “Hate” (Player one dominion), “Loathe” (Player one dominion), and “Resent” (Player two dominion).

Note that if the “somewhat related” option had been toggled off, the GM would have deemed “Resent” to be a non-related word, and would have judged this move by player two to be a foul, indicating such by displaying a message like “Unrelated Word Foul!” The consequences of a foul are explained in a separate paragraph below.

Gameplay continues through n amount of additional rounds, depending upon the preferences elected by the players during the setup of the game. In the default embodiment, gameplay proceeds until the queue comprises 10 words at the conclusion of any round. Scoring may be applied according to the absolute number of words under each players' dominion, the number of letters in said words, or according to a sum of point values associated with individual words and letters, and the like.

A further example will be presented here to illustrate a third type of semantic interaction between words in this embodiment of the game, and that is the “common category” relationship. Assume that Player One presents a first word “Feelings” in round three. The GM will recognize that “Feelings” is a word denoting a category that semantically includes the three preceding words in the queue, “Hate,” “Loathe,” and “Resent.” The outcome is that “Feelings” appears in the fourth position of the queue on the gameboard and an animated sequence plays declaring “Category capture!” Category capture is a rule which applies when (a) a player presents a word that semantically encompasses at least three consecutive words in the queue, and (b) when the three consecutive related words immediately precede the presented category word, and (c) when the relatedness arises from one, and only one, connotation, definition, or semantic feature of the set of related words. Furthermore, (d) the game will only recognize an attempt to execute a category capture when the player presents the category word to the GM in the plural form, i.e., “Feelings.” Therefore, because the three words “Resent,” “Loathe,” and “Hate” are (a) consecutive in the queue, (b) immediately precedent in the queue, and (c) related by one distinct semantic feature in that they are all denoted by the word “Feelings,” this move represents a valid category capture by Player One. However, if player one had presented the word “Feeling” the word would not have been eligible for category capture because the plural form was not used.

The result of the category capture in this example is the transformation of all three preceding words in the queue, or their “capture,” into the color and style indicative of the dominion of the presenting player one. Thus, Player One is now in control of the entire queue, which comprises four words in order from bottom to top, wherein all four words are colored and styled according to the designation representing Player One, thusly: “Hate,” “Loathe,” “Resent,” and “Feelings.”

In order to illustrate another rule, the following is an isolated example of a round of play. The “Repeated Root Foul” rule forbids the repetition of a common root word among the words in the gameboard queue. Suppose a first word is “Risen” and a responsive word is “Arise.” Because both words derive from the same root word, “Rise,” the responsive word is invalid and will be rejected by the GM. A message might inform the players that a “Repeated Root Foul!” has occurred. A Repeated Root Foul may occur even if the two words having the same root are not played consecutively and regardless of which players present the words. The player committing a Repeated Root Foul may lose a turn, re-attempt the presentation of a word, lose points, forfeit the word to the dominion of an opponent, or suffer some other penalty. The applicability of this rule and its consequences may be toggled and adjusted according to player preferences.

The game may be played on a traditional game board of the type commonly made of cardboard or plastic, which might also be equipped with a painted surface designating a playing area, and which may also utilize various spinners, cardholders, gamepieces, and other trappings accessible to contestants grouped in a single location. The game board may be a platform comprising a video display means for displaying animated graphics, and all or part of the gameboard may be contained on a video display apparatus. The video display apparatus may be a liquid crystal display, an LED-based apparatus, an interactive video screen, or any other video display means suitable for animating characters interactively during the playing of a board game or in response to commands and actions by contestants.

The game may also be played on a personal computer or a personal digital device, including but not limited to a personal digital assistant, an iPhone, an android phone, a digital camera, a tablet PC, a wearable computer, a desktop computer, a laptop computer, a video game console apparatus, and an arcade kiosk. The game may be played simultaneously and interactively by multiple players using different devices in different locations, the gameplay occurring over a network, the internet, a wireless communications system, or other means for achieving communication among divers locations. The game may also be played in a solitaire mode in which a single player competes against an artificial intelligence (i.e., a “computer player” or “robot opponent”).

In one embodiment, the objective of the game is to accumulate a certain number of points, and game success is evaluated ultimately based on point scores. In another embodiment, the objective of the game is to build a sequence of words that remain on the display screen until the sequence reaches a certain length, size, height, or distance from the starting point. In some games, the achievement of victory may be analogous to arriving at an opponent's “territory” by building a ladder or bridge of words up to and into that opponent's virtual territory as identified by the artificial intelligence and displayed on the screen. In still further embodiments an objective may be to construct a shape or to fill an area on an animated background.

The default lexicon of the game is a dictionary or thesaurus in a certain language. Other options include the availability of multiple languages such that the game is “bilingual” or “multilingual,” wherein players may validly present words in differing languages which are evaluated for absolute semantic relationships irrespective of the language. The invention also envisions limited lexicon gameplay options, such as theme-based games, where the validity of words is constrained to a subset of a lexicon. Games in which subset lexicons are used may either operate by programming the GM to disallow non-compliant word entries or to penalize/award words with respect to their compliance. For example, a subset lexicon may comprise words relating only to food, words relating only to a certain movie or entertainment genre, words relating only to places, colors, fashions, and so on.

The word game of the present invention may be played on a network such as the internet, world wide web, the cloud, or other distributed system. In such a networked embodiment, the invention provides an on-line game implemented by means of a computer system comprising a gaming site, a population of N players, a plurality of terminals available to respective players, each terminal being coupled to the gaming site to transmit to the site data input by the respective players and to receive from the site data in return.

The forgoing summary has outlined some features consistent with the present invention in order that the following detailed description thereof may be better understood, and in order that the present contribution to the art may be better appreciated. The present invention is not limited in its application, details, or components merely to those set forth in the following description and illustrations. The present invention resides not merely in any one of the features set forth in this specification, but also in the particular combination of all of the features and improvements claimed. Methods and devices consistent with the present invention are capable of other embodiments. Also, the phraseology and terminology employed herein are for the purpose of description and should not be regarded as limiting unless explicitly stated as such.

### BRIEF DESCRIPTION OF THE DRAWINGS

FIG. 1 is a screen shot showing a first round of gameplay.

FIG. 2 is a screen shot showing a subsequent round of gameplay.

FIG. 3. is a screen shot of a second embodiment of the game after several rounds of play, showing the series of player-presented words with their shading indicating the dominion of each respective player.

### DETAILED DESCRIPTION OF THE DRAWINGS

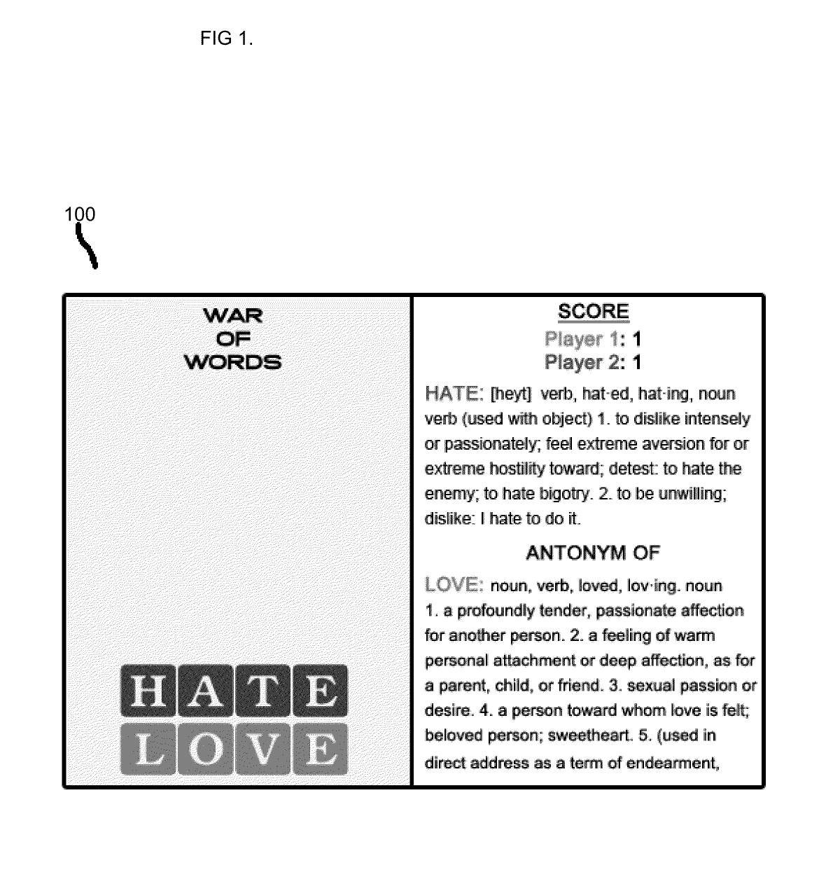

FIG. 1 is a front view of a video display on which the gameboard of the game 100 is displayed during game play. A side panel circumscribes a text display divided into a top and a bottom section. The top section at times may contain displayed text explaining the reasons for a particular action or decision made by the game monitor. A label or header may also be displayed in said top section with an identifying blurb such as “decision,” “information,” “Player name,” or any other descriptive text relevant to the information displayed elsewhere in the top section. The bottom section may contain an analogous header relevant to the semantic information relating to a current or recent word played. In a preferred embodiment, the lower box displays text from the dictionary or semantic reference tool providing the definition, word group, category type, or other semantic criterion(a) that pertains to the words played by said player in the gameboard. A scroll bar or other means for scrolling text may be included in either of these boxes to enable a player to scan backwards through messages and game history information from preceding turns.

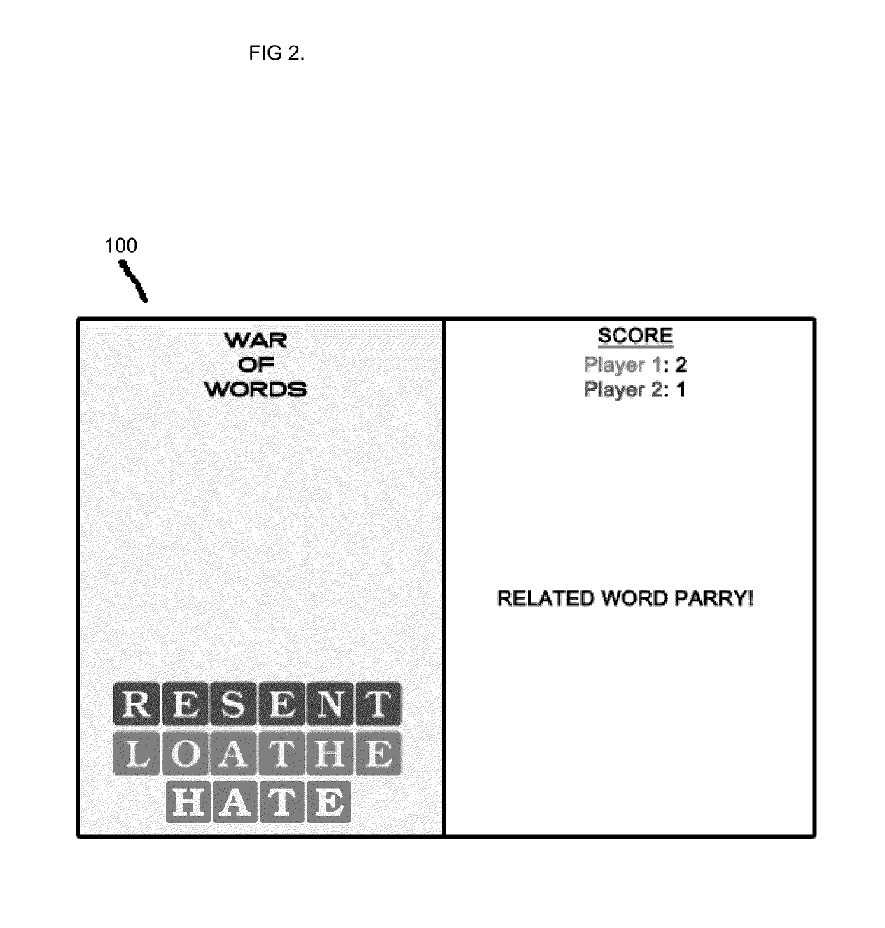

FIG. 2. shows the same view of the same game 100 after a parry word has been played, and the right hand display box indicates that game event by displaying the outcome as text reading “Related Word Parry!” At the same time, a sound effect is issued that indicates this game event. In other embodiments of the game, specific audio video clips may play, such as a movie clip of two swordsman with one of them parrying a blow by the other.

In other preferred embodiments of the game, trigger words and bonus words (or categories) may be programmed into the game monitor where said trigger words and bonus words (or categories), when applicable to a player presented word, generate point score bonuses or other special operations. For example, the game monitor could be set to recognize the bonus category of “Fighting Words,” where any word whose definition relates to warfare, combat, or other aggression is a word in the category. Whenever a player plays a word in said category, a special trigger event is triggered or a point bonus is assigned to a player.

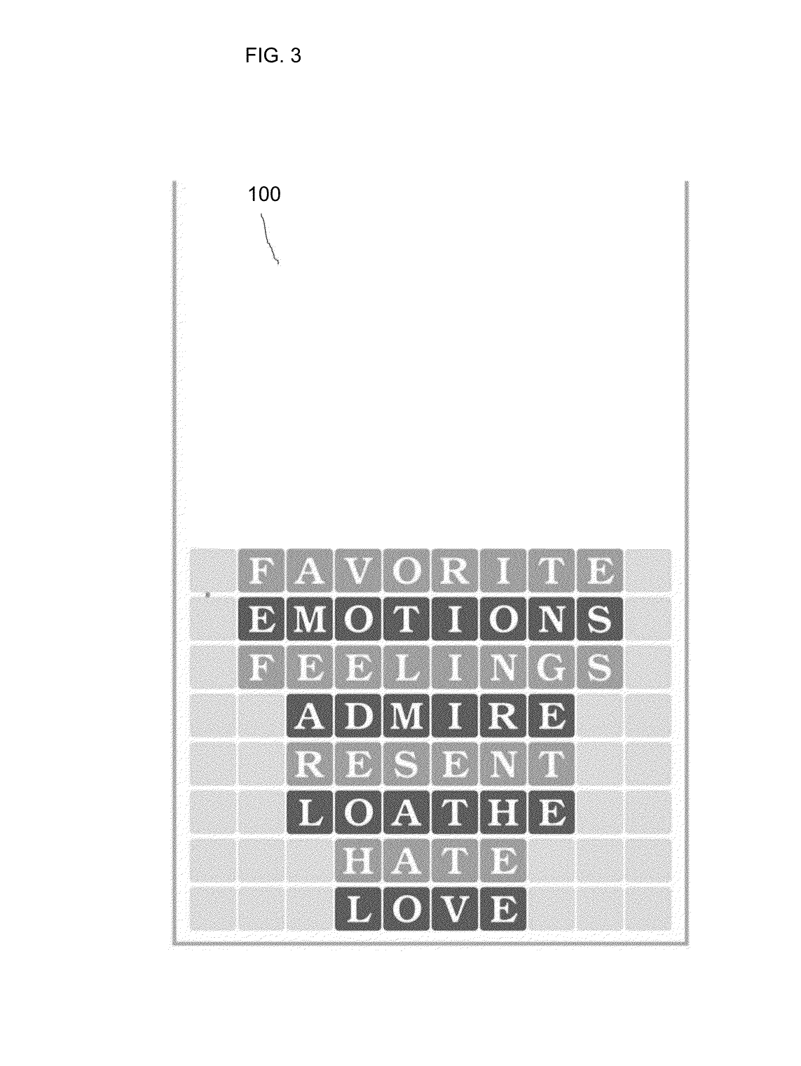

FIG. 3 depicts a screen shot of the game played on an Android-based personal electronic device. Several rounds of gameplay between two players has generated a series of semantically related words arranged in order from first to most recently played going from bottom to top of the game board 100.

### Game Sequence II

The following outline presents a sequence of game parameters for a system of the present invention:

### Initial Setup

1. Each player selects a color, font, or other characteristic to identify words attributable to that player.
2. The default colors are green for Player 1 and red for Player 2.
3. Optional rules are toggled on or off, such as the rule mandating forfeit as a penalty for making an invalid entry (invalid move). Other rules may specify what types of relational criteria may be used in the game and how those criteria influence scoring.
4. The players decide who will be Player 1 or Player 2, Player 1 having the privilege of making the first move in the match by initiating the first round of play. A selection mechanism may be used to determine who will be player one, said selection mechanism comprising for example, the roll of dice, the answering of a quiz, or any other means for determining a winner of a contest.

### Game Play: Round 1!

Player 1 initiates a round of play by entering a first leading word, said entering occurring through typing, speaking, selecting from a menu, or otherwise designating a word, said first leading word then displaying on a video screen of an electronic device.

Rule: The first leading word may be any correctly spelled word in a dictionary.

Player 2 responds by typing a first responsive word that displays directly above, along the y axis of the video screen, the first leading word.

Rule: The first responsive word must be one of a synonym of, an antonym of, or a logically related word to the first leading word.
Rule: Words are related if one word defines a class, group, concept, activity, etcetera, that includes the definition of the other word. It is immaterial whether the responsive word is the more generic or the more specific member of the logical relationship.
Rule: A word typed by a player is “controlled” by that player, indicated by the color or font or other specified appearance of the text, unless and until control over the word is seized by the other player. Words on the screen are affected by subsequently typed words such that control over any word on the video screen may be seized during any round of a match, according to rules explained in later sections.

IF Player 2 successfully types a synonym, then player 2 has parried.

Both words remain visible on the video screen in their original positions and in their original colors, the first responsive word stacked above the first leading word.
No points are assigned to either player, and player 1 retains control of the round.
Another round begins when player 1 types a second leading word, whose location on the video screen is determined by its relationship to the existing words as explained in section B below.

IF Player 2 successfully types an antonym, then player 2 has rebutted. The coloration of both words becomes red (or the color of player 2), and both words remain visible on the video screen in their original positions, the first responsive word stacked above the first leading word. No points are assigned to either player, but player 2 acquires control of the round.

Another round begins when player 2 types a second leading word, whose location on the video screen is determined by its relationship to the existing words as explained in section B below.

IF Player 2 successfully types a semantically related word, then player 2 has dodged. The first leading word disappears from the video screen, and the first responsive word moves downwards, according to the y-axis, on the video screen to occupy its former position.

The first responsive word is thus transformed into a new leading word, and the round proceeds with another turn by Player 1.
Player 1 must now type a first responsive word to the new leading word according to the same rules applicable to Player 2 as in the first turn.
IF the first responsive word is not a synonym of, an antonym of, or a logically related word to the first leading word, then player 1 has won the match.
Player 1 is assigned points.

Note: In this example, points may be awarded at the conclusion of a match. Points are awarded in proportion to the number of words that are (1) visible on the screen and (2) controlled by the winning player, as of the time the match is won. Alternatively, letters may have point scores associated with them as is common in crossword games like scrabble. In which case point score is determined by the sum of all letter scores in words controlled by a player. The present example describes a match comprising only one round of play, and thus the winning player has typed only one word on the screen. However, future examples presented below will explain how a match may progress through multiple rounds and how such a match may result in there being three, four, or many words, displayed on the screen simultaneously.

Both words are cleared from the display and the game returns to the beginning stage.
Player 1 retains control of the round.
A new match begins from round 1 when player 1 types a first leading word.

### Additional Rules and Optional Considerations:

Whenever any player makes an invalid entry, that player immediately forfeits the match to the other player, but the score is calculated differently from a bona fide victory.

An invalid entry (invalid move) occurs when a player types a string of characters that do not amount to a correctly spelled word in the governing dictionary.
In a forfeit, the forfeiting player is docked points while the winning player receives no points. The forfeiting player is docked points in proportion to the TOTAL number of words on the screen at the time of forfeit, regardless of the number of words under either player's individual control. Note: If Player 1 flubs the opening move by failing to type a valid first leading word, Player 1 is docked 2 points despite there being no valid words on the screen. The rule of forfeit is an advanced option that should be programmed with a toggle so it can be set according to player preferences at the beginning of a match or series. In the preferred embodiment, playing an antonym upon a stack of words where the responsive word is an antonym of the first presented word and other words in the stack played by opponents, then all antonyms of the responsive word are eliminated from the stack.

### Gameplay Options and Special Rules

Ranked Relationships:

In some thesauri and dictionaries, the antonyms, synonyms, definitions and connotations corresponding to a particular query word may be categorized according to strength, commonality, or preeminence, in that said thesauri and dictionaries may list a first set of synonyms, antonyms, and definitions for said query word followed by one more inferior sets ranked in descending order (i.e., second, third, fourth, etc.). For example, a thesaurus may teach that the query word “good” has a first antonym, “bad,” plus a set of secondary antonyms comprising the words “detestable,” “disagreeable,” “unpleasant,” and so on. For another example, a dictionary may define the query noun, “patent,” according to a first definition, which might be “the exclusive right granted by a government to an inventor to manufacture, use, or sell an invention for a certain number of years;” a second definition, which might be “an invention or process protected by this right;” a third definition, which might be “an official document conferring such a right (e.g., ‘letters patent’);” a fourth definition, which might be “the instrument by which the government conveys the legal fee-simple title to public land;” and a fifth definition, which might be “a type of leather.” Various embodiments of the game may comprise a GM that applies such ranked distinctions to judgments of relatedness according to academic canon, common usage, player preferences, or any other regimen.

Distinctions of Grammar and Tense:

The GM may base its judgment of relatedness among words according to grammatical rules and matching verb tenses. In other words, the GM may deem two presented words as related or unrelated according to whether they agree in verb tense or other grammatical factors. The particular rules applied by the GM may be immutably pre-programmed in the GM or selectively adjustable according to player preferences.

Teach:

Presented words may have a colloquial associations in the opinions of the game players despite not being associated by any relationship in a dictionary or a thesaurus. In such a case, by agreement among or decision of one or more players, the GM may be “taught” to associate the words together. This gameplay option is called the “teach” function because the player or players are instructing—essentially, “teaching”—the GM to hereafter judge the two words as related. The relationship may be generic or qualified according to some criterion or criteria such as “slang,” “idiom,” “consent” and the like. The GM is thenceforth programmed to apply the “taught” relationship in the future, such as when the same players compete together again or when a certain player or players challenges new opponents using the GM so “taught” or instructed in said relationship(s).

Unteach:

Conversely, if two or more words are deemed related by the GM, yet a player or players objects to the relatedness, then by the consent of one or more players the GM may be instructed to eliminate the condition of relatedness between said words from the GM. This “unteaching” would affect future gameplay in a similar manner and in the various circumstances as aforementioned in the description of “teaching.”

All modifications of gameplay, such as those regarding to relational databases and other relational criteria, particularly those accomplished by the teach and unteach functions, maybe shared with a central game server or database on a remote host computer. From there, they may be distributed to other players or collected by a third party to maintain a real-time knowledge base of player preferences. This allows the game to evolve, and it allows a manufacturer to use the information to provide updates to the artificial intelligence of the game. These updates can be incorporated into newly manufactured versions of the game or distributed for download by existing owners and licensees of various embodiments of the game.

Initial Setup Options:

variable gameplay options may comprise determinations of the number of words necessary to achieve victory; the types of semantic relationships recognized by the game; the number of consecutive words which must exist in the queue and how strictly they must be consecutively arranged in order for category captures and similar group effects to occur; how points are allocated for various outcomes; game victory conditions; game graphics options, skin appearances, and entertaining themes; etc.

### Adaptations for Gameplay on Electronic Devices, Computer Systems, and Networks

The word game of the present invention and all of its embodiments may be played on any electronic device, digital appliance, game console, and the like, and may be played on any network or distributed computer system, may be played by multiple players in disparate locations using any suitable communications means, and may be played in a solitary mode and/or such that at least one opponent is an artificial intelligence. Said word games and embodiments may also be played on dedicated gameboards that incorporate electronic components and network capability wherein a game of the present invention is suitable for packaging in a box set and commercially distributed in a manner analogous to traditional board games and toy store products.

When a game of the present invention is part of a dedicated box set as indicated above, said gameboard and box set may be integrated with audio and video performance and display means, with input and output devices such as speakers, microphones, keyboards, headsets, and means for interacting with computerized, electronic, and other elements of a dedicated game system, and the game may feature compatibility and/or connectivity with video game consoles, local area networks, home computers and networks, portable computers, cellular phones and networks, Bluetooth and wireless communication means, means for interacting with website, remote computer system and networks; said box sets may also comprise read/write electronic media storage devices, means for accessing and consulting digitized lexicons, thesauri, and relational databases for storing, organizing, and retrieving information about semantic relationships between words, and game pieces characteristic of traditional board games such as trinkets, statuettes, playing cards, and the like. One example of a board game integrated with digital components is described in U.S. Pat. No. 6,340,159 to Giangrante, entitled “‘Double Cross’ Game Show,” issued Jan. 22, 2002, the entirety of which is incorporated by reference herein.

A game of the present invention may comprise control means for executing a program; geometry calculating means for performing co-ordinate conversions for a plurality of polygons; rendering processing means for generating display images by converting the three-dimensional co-ordinates generated by said geometry calculating means into two-dimensional co-ordinates; programs executed and controlled by said control means; databases comprising lexicons (e.g., dictionaries), thesauri, and word association tables; means for making queries using key words or for otherwise consulting to internet search engines, web pages, distributed networks and remote databases as well as means for making queries to such sites and databases; means for deriving information from said queries and destinations and then downloading said information into the system of the game; means for consulting relational databases and/or for determining whether two or more words are related semantically and/or for determining the nature of said semantic relationships; means for displaying forms and prompts allowing players to input text; storage media storing sound and audio files; means for retrieving sound and audio files for playback in the game system; means for generating characters and animations on a digital gameboard of the game system;

The artificial intelligence of the game monitor (“GM”) in any embodiment of the present invention may be programmed according to methods known in the art, or may be specially adapted for the game by its manufacturer. Said GM may also be modifiable at the option of end users during and after gameplay, such that the GM can learn preferences of players, update its knowledge base or rules, send information about gameplay to a remote location, to the manufacturer, to other game systems, and any third parties, where sent said information may be used to monitor, evaluate, and improve gameplay. Conversely, the game may receive input from such remote and other third parties to update the GM or other digital elements of the game system, such as to update lexicons and semantic databases, artificial intelligence parameters and operational rules, and facilitate other changes that facilitate gameplay. It is expected that the game and embodiments thereof will be played, observed, and broadcast remotely. Gameplay can be watched by remote audiences, digitally recorded for storage and playback, and posted on the world wide web or otherwise published.

### Example Game Variant (WORDSPIRE)

In another preferred embodiment, gameplay begins with two words pre-positioned on the board comprising a starting-word and a goal-word. The objective is to play off of the starting-word according to the semantic relationship strategies described above until a word is played which is semantically related to the target-word. For example, if the starting-word were LOVE and the target-word were POPPY, gameplay would proceed as if a first player had presented the word LOVE and gameplay would end when a player presented, for example, the word FLOWER, because flower is a synonym of poppy. The sequence might proceed as follows, where each word is being presented by one of two players in alternating turns and wherein words played by player 1 are underlined for illustrative purposes: LOVE, HATE, CHARITY, SELFISHNESS, MEAN, INTEND, WANT, EARN, GIVE, GIFT, FLOWERS.

Player 2 wins in this example by playing a word, FLOWERS, that is a synonym of POPPY, or that is incidentally also a genus comprising the species poppy. The number (singular or plural forms) of words can be set in the game controls to be irrelevant or restrictive according to player preference before the game starts. Notice how player 1 attempts to prevent player 2 from getting close to the concept of flowers in the second round when player 2 played the word CHARITY. Player 1 countered with the antonym SELFISHNESS which is semantically distant from the concept of a poppy. Nevertheless, player 2 walked back to the concept of charity later by playing the word GIVE as an antonym of EARN, luring player 1 into playing the synonym GIFT which allowed player 2 to play the winning word FLOWERS, which qualify as a type of gift under a genus-species relationship or in some lexicons as a synonym. Also notice that player 1 took advantage of the fact that the word MEAN has multiple definitions. In a preferred embodiment it is legal according to the rules of gameplay to play a word that is semantically related to an alternative definition of a word compared to that definition which originally made the word valid in relationship to its preceding word in gameplay. In this case, MEAN was played as a synonym of SELFISHNESS, invoking its definition as a personality trait, but the next word played off of MEAN according to its verbal definition that is equivalent to INTEND.

The above embodiment of the game of the present invention may be sold under the tradename “Wordspire” which is a contraction of the words “word” and “aspire,” but which also connotes the building of a tall structure, i.e., a “spire,” signifying the stack of words that build towards the goal word as gameplay progresses.

### Example Game Variant (KUNG FU CHALLENGE)

This embodiment applies any of the rules and gameplay but is represented visually by two animated figurines that are engaged in hand to hand combat. A synonym is a parry while an antonym lands a blow. Generally, this embodiment represents the capacity to merge action into the word-based gameplay. The means for outputting data from the game monitor may incorporate any computer graphics and animation techniques, hardware, and software known in the art.

### Applying Lexical Semantic Relations

The game may incorporate its own internal or proprietary methods and data for determining semantic relationships among words or it may derive them from external, and even publically available, resources. During gameplay, the GM may lookup semantic data on the internet or other reference sources, as by direct querying to a host or by use of a search engine. The art of determining semantic relationships and designing artificial intelligences to perform semantic comparisons is a busy area within the information technology sector. Persons of ordinary skill in the art will appreciate that this knowledge is constantly expanding and that many schools of thought exist presenting competing theories and methodologies. Different embodiments of the present invention may borrow any and all of such theories and methods for the artificial intelligence of the game.

It should be emphasized that the above described embodiments of the present invention exemplify some, but not all, possible implementations of the present invention and have been set forth in order to provide a clear understanding of its qualities. Those skilled in the art will appreciate that the conception upon which this disclosure is based may readily be utilized as a basis for designing of other structures, methods, and systems for carrying out the several purposes of the present invention. The following claims should be regarded as encompassing equivalent and various constructions insofar as they do not depart from the spirit and scope of the methods and devices consistent with the present invention.

I claim:

1. A word game comprising:
a system enabling two or more Players to engage in a competition comprising alternating turns, wherein each of said turns comprises the presentation by each of said Players of a player-presented word, wherein a basis for said competition comprises a goal of creating one or more semantic relationships between the player-presented word presented by a Current Player and one or more of a player-presented word presented by any of said Players, such that said alternating turns generate a series of one or more player-presented words,
a gameboard comprising at least one means for displaying one or more visual representations of said player-presented words on said gameboard and comprising at least one means for visually representing said semantic relationships among said player-presented words,
a game manager comprising at least one means for electronically managing one or more events in said system, said game manager comprising
at least one electronic computing apparatus,
at least one data storage element comprising at least one lexicon and at least one set of game rules,
at least one means for inputting data into said game manager, wherein said means for inputting comprises at least one means for enabling said Players to input data representing said player-presented words into said game manager,
at least one means for outputting data from said game manager, wherein said means for outputting comprises at least one video display apparatus and at least one means for displaying said one or more visual representations of said player-presented words on said gameboard,
at least one computation means for querying said lexicon with said player-presented words according to said game rules,
at least one computation means for evaluating one or more of said semantic relationships among said player-presented words,
at least one computation means for assigning one or more score values to said player-presented words,
at least one means for generating one or more of said events in said system in response to one or more of any of said computation means and any of said means for inputting.

2. The word game of claim 1 wherein said two or more Players comprises at least one of a computer opponent, wherein said computer opponent comprises an artificial intelligence programmed to play said game.

3. The word game of claim 1 wherein said at least one means for inputting data comprises a means for electronically recognizing human speech.

4. The word game of claim 1 wherein said at least one means for outputting data comprises one or more audio output means for generating sound.

5. The word game of claim 1, further comprising a networking means for connecting said game system to a network.

6. The word presentation game of claim 5, wherein said network is the Internet.

7. The word presentation game of claim 1, wherein said game manager further comprises one or more of a library of media clips, said media clips comprising audio-video content data, and at least one means for outputting said content data of said media clips in response to one or more of said events in said system according to one or more trigger-event rules, where said trigger-event rules specify conditions for the game monitor to recognize and respond to by outputting a particular instance of one or more of said media clips.
